(19) United States
(12) Patent Application Publication
(10) Pub. No.: US 2018/0228181 A1
(43) Pub. Date: Aug. 16, 2018

(54) Microbial Composition

(71) Applicant: CORPORACIÓN COLOMBIANA DE INVESTIGACIÓN AGROPECUARIA-CORPOICA, Mosquera (CO)

(72) Inventors: Fernando Rodríguez Villamizar, Mosquera (CO); Martha Isabel Gómez Álvarez, Mosquera (CO); Erika Paola Grijalba Bernal, Mosquera (CO)

(73) Assignee: CORPORACIÓN COLOMBIANA DE INVESTIGACIÓN AGROPECUARIA-CORPOICA, Mosquera (CO)

(21) Appl. No.: 15/751,083

(22) PCT Filed: Aug. 7, 2015
(86) PCT No.: PCT/IB2015/056033

§ 371 Date: Feb. 7, 2018

(51) Int. Cl. A23K 10/18; A23K 50/10

(52) U.S. Cl. CPC A23K 10/18; A23Y 2240/00; A23K 50/10

(57) ABSTRACT

The present invention refers to a microbial composition comprising probiotic microorganisms, adjuvants and an acceptable carrier. The composition of the invention is stable and shows efficacy in reducing the incidence of diarrhea in calves and also achieves a significant increase in their body weight.

### FIELD OF THE INVENTION

The present invention relates to the pharmaceutical art, particularly to the field of veterinary medical compositions. The invention refers to a microbial composition comprising probiotic microorganisms for reducing diarrhea and increasing neonate bovine vitality.

### PRIOR ART

The FAO defines probiotics as live microorganisms that upon administration in appropriate dosages, produce beneficial health effects in receiving hosts (1). A probiotic product is comprised of surviving microorganisms and that can be introduced in different digestive tract organs such as the stomach, small intestine or the colon, aiming to improve host intestinal flora function thus helping to completely breakdown food for later absorption (2).

In addition, the presence of probiotics in intestinal flora may induce some proteins to suffer conformational changes and therefore, activate intracellular biochemical mechanisms which favor the production of inflammation mediators, prompting cellular differentiation or cellular apoptosis and activating immune responses when facing any possible infection (3).

Ruminant mammals possess a very particular morphology and digestive physiology. The capacity that ruminant mammals have to uptake fiber carbohydrates from diet is due to the rumen (paunch), the reticulum (honeycomb) and the omasum (manyplies), organs that precede the abomasum (true stomach). The rumen is a fermentation chamber with an anaerobic environment and variable pH allowing for high retention of long cattle feed particles and stimulates rumination and body metabolism, maintaining an adequate environment for growth and the reproduction of microorganisms.

Ruminant microorganisms are benefited due to the lack of oxygen, product of urea hydrolysis, a process requiring oxygen consumption by bacteria adhered to the wall. These microorganisms have the capacity of digesting complex polysaccharides (for example, cellulose, hemicellulose, pectin) in order to produce carbohydrates and they also make use of non-proteic nitrogen for amino acid and protein synthesis (5).

Grass-fed cattle prompts bacteria present in the rumen to be of the fibrolytic type such as Butyrivibrio fibrisolvens, Ruminococcus flavefaciens and Fibrobacter succinogenes (5). In contrast, if the cattle is fed a high percentage of concentrate, acidolactic bacteria growth is favored such as Lactobacillus sp y Streptococus bovis (6).

Upon birth, calf gastrointestinal tracts are sterile and intestinal flora microorganisms are only introduced upon contact with their mothers. However, in new bovine production systems, calves are separated from their mothers upon birth and fed milk substitutes, without even allowing them to be fed colostrum, notably altering the development of their intestinal flora. Consequently, the primary cause of calf disease in these production systems up until three months old is diarrhea.

For the treatment of diarrhea in bovines, both antibiotic agents that can generate undesirable antimicrobial resistance or microorganism-based probiotic products can be used. Some commercial probiotic products for cattle such as Prokura®, Provita®, BioBoost® y Probios Calf® contain non-ruminant aerobic microorganisms, such as Lactobacillus acidophilus, Lactobacillus plantarum, Bifidobacterium bifidum, and Bacillus subtilis (7).

U.S. Pat. No. 3,956,482 describes a ruminant microorganism composition comprising Megasphaera elsdenii, Streptococcus boviss, Lactobacillus acidophilus, Bifidobacterium adolescentes, Bacteroides ruminicola and Butyrivibrio fibrisolvens, which are introduced into a nutritional medium and fed to the animal during the first 24 hours and/or the period comprising 80 to 140 days old.

WO 2012147044 discloses a method for reducing the production of methane in ruminants comprising the administration of a blend of bacteria strains of the genus Propionibacterium and Lactobacillus, preferably Propionibacterium jensenii P63, Lactobacillus plantarum Lp115 and Lactobacillus rhamnosus Lr32. Likewise, the document highlights that the administration of the microorganisms also stimulate the animal's growth.

The publication “Bacterial direct-fed microbials in ruminant diets: performance response and mode of action” describes the beneficial effects of the administration of microorganism compositions such as Lactobacillus, Enterococcus, Streptococcus y Bifidobacterium in bovine feed (8). Amongst the favorable effects, the generation of an adequate intestinal microflora, the prevention of enteropathogenic organisms flourishing and daily weight gain, are mentioned.

With the purpose of improving competitiveness of dairy and bovine beef production systems, functional alternatives for the treatment of diarrhea and antibiotic replacement is necessary. Undoubtedly, a good alternative is developing probiotic products that can be administered to bovines in order to prevent disease and increase vitality.

### BRIEF DESCRIPTION OF THE INVENTION

The present invention refers to a microbial composition comprising at least one probiotic microorganism selected from the group consisting of Fibrobacter succinogenes, Ruminococcus flavefaciens, Streptococcus bovis and Butytrivibrio fibrisolvens, together with adjuvants and an acceptable carrier. The composition of the invention exhibits adequate efficacy in reducing the incidence of diarrhea and promotes weight gain in bovine neonates.

### BRIEF DESCRIPTION OF THE DRAWINGS

FIG. 1. Corresponds to Log viability (CFU/ml) results of the microbial composition of Example 2 stored at 4° C.+/−2° C. during 6 months. Same letter treatments do not show significant differences according to Tukey's test (95%).

FIG. 2. Corresponds to Log viability (CFU/ml) results of the microbial composition of Example 2 stored at 18° C.+/−2° C. during 6 months. Same letter treatments do not show significant differences according to Tukey's test (95%).

### DETAILED DESCRIPTION OF THE INVENTION

The microbial compositions of the invention comprise at least one probiotic microorganism as an active ingredient, adjuvants and an acceptable carrier. The probiotic microorganisms of the subject invention may be, amongst others, facultative anaerobic bacteria or obligate anaerobic bacteria. The definition, features and properties of each one can be found in detail in the text Manual of Determinative Bacteriology (9) found herein entirely as reference.

In a preferred embodiment of the invention, the compositions comprise, as active ingredients, anaerobic microorganisms selected from the group consisting of Fibrobacter succinogenes, Ruminococcus flavefaciens, Streptococcus bovis and Butytrivibrio fibrisolven, which may be quantified, using concentration and viability thereof, as units of measurement. Preferably, the concentration of each one of said microorganisms of the active ingredient of the subject invention ranges from 1×10³ to 1×10¹¹ CFU/ml, more preferably between 1×10⁶ and 1×10¹⁰ CFU/ml, and even more preferably, 1×10⁹ CFU/ml.

The active ingredient can be contained in water, in a solvent, in a mix of solvents, in liquid culture media, in a freeze-dried powder, in an aqueous suspension or in a concentrated paste, either in equal or different amounts of each of the probiotic microorganisms.

The compositions of the invention include, in addition to the active ingredient, several adjuvants with specific functions which give shape and features to the final presentation (for example, forming emulsions, regulating pH, improving stability and increasing shelf life during storage). The active ingredient concentration in the compositions of the invention are preferably between 0.1% and 99.9% (w/w), more preferably between 20.0% and 60.0% (w/w) and even more preferably 40% (w/w).

As adjuvants, all those known in prior art are included, amongst which water, organic solvents, mineral oils, vegetable oils, such as soy, corn oil, canola oil, olive oil, coconut oil, wheat germ oil and blends thereof, polysorbates, polyols, polymers, lipids, saponifiable lipids, support substances (for example, kaolins, talc, bentonites, silicates), diluents, emulsifying agents, viscous agents, surfactants, pH regulators, stabilizers, and colorants are included. Adjuvant concentration in compositions of the subject invention, either individually or together, preferably range between 0.01 and 99.9% (w/w) and more preferably between 0.1 and 60.0% (w/w).

Emulsifying agents include, but are not limited to polysorbates, sorbitan esters, noniphenol, sodium laurylsulfate and blends thereof. The viscous agents include, but are not limited to polymers, gums, hydrocolloids, finely divided solids, waxes and blends thereof. pH regulating agents include but are not limited to carbonates, phosphates, citrates and borates.

The term “acceptable carrier” as for the present invention, can be defined as a blend of substances (for example, solvents, solutions, emulsions, and suspensions) capable of containing the active ingredient and/or adjuvants, without its ability to carry out the desired functions being affected.

The compositions of the invention can be found in the form of powders, soluble granulates, dispersible granulates, dispersible tablets, suspensions or emulsions. The term “soluble granulate” intends to include granules for later application after dissolving the active ingredient in water as a solution, optionally containing insoluble auxiliary substances. The term “dispersible granulate” refers to granules to be applied as a suspension, after their disintegration and dispersion in water or other aqueous solvents.

In the case of the present invention, the term “dispersible tablet” refers to a tablet formulation to be individually used to form a suspension of the active ingredient after being disintegrated in water. The term “suspension” refers to liquids containing the active ingredient and the adjuvant stably suspended, either to be directly applied or diluted in water. The term “emulsion” intends to include heterodisperse systems having several grades of viscosity, giving way to liquid or semisolid systems, which may or may not be encapsulated, and used to generate solid pharmaceutical forms.

In order to prepare the compositions of the subject invention, any conventional method described in prior art according to the pharmaceutical form desired may be used, which may be found in detail in textbooks such as “Industrial Pharmaceutical Technology” or “The Science and Practice of Pharmacy”, which are entirely contained herein as reference (10, 11). In a preferred embodiment, an emulsion-type composition may be prepared by mixing an aqueous phase containing the active ingredient, with an oil phase containing the emulsifying agents. Once both phases are mixed, the emulsion is gasified using CO₂ and pH regulators and stabilizing agents are added.

In order to determine the concentration and/or the viability of the probiotic microorganisms present in the compositions of the subject invention, any conventional technique known by an expert in the field may be used. One of said techniques is one called “Roll tube” described in Rodriguez, et al., (12), which is specified for anaerobic microorganisms.

In a preferred embodiment, the microbial composition of the invention is in the form of an emulsion, having anaerobic probiotic microorganisms as the active ingredient and adjuvants such as emulsifiers, polymers and pH regulators which improve viability, efficacy and shelf life of the product.

In an even more preferred embodiment, the microbial composition of the subject invention is a water-oil (W/O) emulsion, wherein the anaerobic microorganisms are found in the emulsion's aqueous phase (internal phase), covered by the oil phase (external phase) offering protection against environmental oxygen. The emulsion's aqueous phase is an adequate culture medium containing the microorganisms, whereas the emulsion's oil phase may comprise, among others, vegetable oils, polysorbates and saponifiable lipids which favor the formation of the W/O emulsion.

The term “adequate culture medium” according to the present invention, refers to any culture medium containing the nutrient sources and trace metals that are necessary for anaerobic microorganism growth. In a preferred embodiment, the adequate culture medium comprises glucose, yeast extract, an anaerobic indicator, sodium bicarbonate, cysteine hydrochloride, volatile fatty acids, KHPO₄, KH₂PO₄, ammonium sulfate, NaCl, MgSO₄ and CaCl₂ at concentrations between 0.0001 and 100.0 g/L each.

The following examples illustrate the invention, without the inventive concept being limited thereof.

### EXAMPLES

### Example 1: Obtaining Strains of Butyrivibrio Fibrisolvens (B9), Streptococcus bovis (C2), Ruminococcus flavefaciens (Rf) and Fibrobacter Succinogenes (Fs) from the Active Ingredient of the Microbial Composition

Probiotic bacteria were isolated from Colombian and foreign bovine rumen and from a wild herbivore. Butyrivibrio fibrisolvens (B9) was isolated from a Holstein-Friesand breed bovine, Streptococcus bovis (C2) was isolated from a Harton del Valle breed bovine (Department of Valle de Cauca, Colombia), Ruminococcus flavefaciens (Rf) was isolated from a Lucerna breed bovine and Fibrobacter succinogenes (Fs) was isolated from a Capybara (chigüiro) from the Casanare region in Colombia. The strains were reactivated in a cellobiose-glucose-rich culture media and incubated at 39° C. for three days.

The strains are found stored at the Microorganism Germoplasm Bank of Animal Nutrition Interest at CORPOICA (BGMINA—Colombia).

### Example 2. Preparation of an Emulsion-Type Microbial Composition

A W/O emulsion type composition was prepared using a blend of Butyrivibrio fibrisolvens (B9), Streptococcus bovis (C2), Ruminococcus flavefaciens (Rf) and Fibrobacter succinogenes (Fs), as active ingredients.

The microorganisms were obtained according to Example 1. Oil phase components (sunflower oil, polysorbate 20 and lectin) were set in a pressurized cooking pot, mixed using a Dynamic® homogenizer and gasified using CO₂ during 10 minutes. Thereafter, this oil phase was mixed with the aqueous phase (culture media of each bacteria in a 1:1 proportion) using a Dynamic® homogenizer at the maximum level of stirring during 5 minutes. The emulsion formed was also gasified using CO₂. Table 1 shows the concentration of each component.

TABLE 1

| COMPONENT | CONCENTRATION (% W/W) |
|---|---|
| Culture media with bacteria (1 × 10⁹ | 40.00 |
| CFU/mL) | |
| Sunflower oil | 49.96 |
| Polysorbate 20 | 1.84 |
| Liquid lectin | 5.95 |
| Hydrocolloid | 1.50 |
| Sodium bicarbonate | 0.75 |

### Example 3. Determination of Quality Parameters of the Microbial Composition

Quality parameters such as concentration (expressed as CFU/mL), pH and contaminant content were determined in a microbial composition obtained according to Example 2.

In order to determine the concentration, 1 ml of each sample was taken and serial dilutions were carried out. Starting from 1×10⁻⁷, 1×10⁻⁸ y 1×10⁻⁹ dilutions, tubes having melted cellobiose agar were inoculated. Each seeded tube was subject to a “rolling”. Thereafter, it was left in incubation for 72 hours at a temperature of 39° C. and a colony forming unit (CFU) count was made. In order to evaluate pH, a Consort C931® electrochemical analyzer was used, previously calibrated with pH 4 and 7 buffer solutions.

In order to establish contaminant content, 1 ml of each sample was taken and serial dilutions (10⁻¹ a 10⁻²) were made in 4% saline solution. Thereafter, 0.1 ml of the 1×10⁻² dilution was inoculated in Petri dishes having Nutrition Agar during 24 hours at 37° C.+/−2° C. in order to determine the aerobic bacteria present and in PDA media for 7 days at 25° C.+/−2° C. and determine filamentous fungi. Results are shown on Table 2.

TABLE 2

| | | | Contaminant content | |
|---|---|---|---|---|
| | | | Aerobic | Filamentous |
| Microbial | Concentration | | Bacteria | fungi |
| Composition | (CFU/mL) | pH | (CFU/mL) | (CFU/mL) |
| Sample 1 | 1.0 × 10⁹ | 7.16 | <10³ | <10³ |
| Sample 2 | 3.2 × 10⁹ | 7.20 | <10³ | <10³ |
| Sample 3 | 2.30 × 10⁹ | 7.20 | <10³ | <10³ |

### Example 4. Stability Assay of the Microbial Composition

The stability under storage conditions of a microbial composition obtained according to Example 2 was determined. The samples were stored at a temperature of 4° C.+/−2° C. (T1) and 18° C.+/−2° C. (T2), during 6 months. In order to perform the assay, 12 ml of the microbial composition was taken in a high density polypropylene dosing syringe, which corresponded to the experimental unit of each treatment.

The stability assay had a completely random experimental design with repeated measures in time and all measurements were done in triplicate. The stability study results were subject to a variance analysis and later to medium comparison using Tukey's test (95%).

At baseline zero and after six months in storage, three samples were taken of each treatment and viability, contamination (aerobe bacteria and fungi) and pH were assayed according to Example 3. Table 3 shows the pH values obtained of the three samples assayed at each temperature, which are near 7.0. (10).

TABLE 3

pH

| SAMPLE | (T1) 4° C. ± 2° C. | (T2) 18° C. ± 2° C. |
|---|---|---|
| 1 | 7.33 | 7.57 |
| 2 | 7.32 | 7.65 |
| 3 | 7.31 | 7.72 |

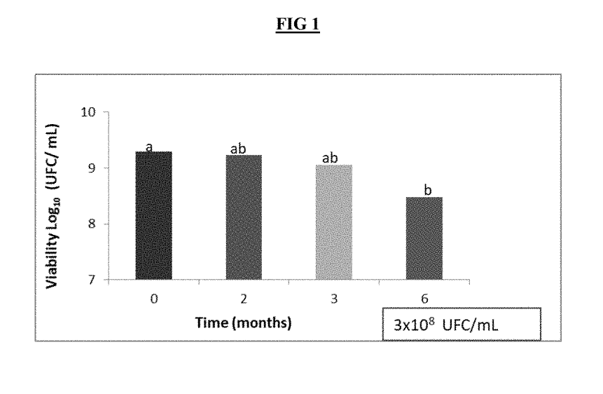

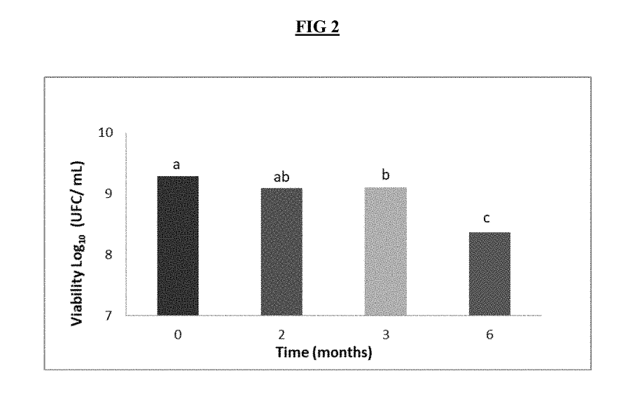

The viability results obtained for each one of the treatments are illustrated in FIG. 1 and in FIG. 2. FIG. 1 shows the results for treatment stored at 4° C., demonstrating that after 6 months in storage, a significant drop in viability compared to baseline was observed. However, the microorganism concentration is no less than 1×10⁸ (FIG. 1).

Viability at 18° C. also had a significant drop after 6 months in storage, but it was also not less than 1×10⁸ (FIG. 2). The viability drop of the microorganisms was 1 Log after 6 months in storage for both storage temperatures assayed.

Initially, at baseline zero, the content of aerobe bacteria and fungi was less than 10³ CFIU/mL for all treatments. After two months in storage, at the two temperatures assayed, the treatments stored at 4° C.+/−2° C. showed a contaminant aerobe bacteria and fungi content lesser than 1×10⁴ CFU/ml. Likewise, at a temperature of 18° C.+/−2° C., it was found that the bacterial and fungal content held steady at a range of 1×10⁴ CFU/ml. No case reported the presence of pathogenic bacteria.

### Example 4. Biological Activity Assay of the Microbial Composition Under Field Conditions

One hundred and eighty calves (180) were randomly assigned upon birth to three experimental groups:
Group 1: Administration of fresh microbial composition
Group 2: Administration of microbial composition stored 6 months
Group 3: No microbial composition administered.

Using a completely random design having a 3×2 factorial, 2 variables were analyzed: diarrhea incidence and body weight gain. Each calf in groups 1 and 2 received 12 dosages of 10 ml/day orally of a microbial composition according to Example 3. The microbial composition was administered during 10 consecutive days, starting on the date of birth (D1), and the following dosages were fed at day 15 and 30 (D15 and D30).

An electronic balance was used monthly to determine the weight gain of the calves, starting on D1 until three months old. The presence of diarrhea was determined through direct observation in each animal and its frequency was documented. The microbial composition assayed demonstrated it indeed reduced the incidence of diarrhea and increased body weight in the assayed animals. The results are shown on Table 4.

TABLE 4

| | Average weight | Weight | Average | |
|---|---|---|---|---|
| | upon weaning | gain | Diarrhea | |
| Treatment | (Kg) | (g) | Episodes/Animal | Significance |
| Group 1 | 112 | 800-900 | 2 | P < 0.01 |
| Group 2 | 105 | 800-900 | 2 | P < 0.01 |
| Control | 99 | 500-600 | 7 | P < 0.01 |

### REFERENCES

1. Hume, M. E. 2011. Food safety symposium: Potential impact of reduced antibiotic use and the roles of prebiotics, probiotics, and other alternatives in antibiotic-free broiler production. Historic perspectives: Prebiotics, probiotics, and other alternatives to antibiotics. Poultry Science. 90: 2663-2669.
2. Frizzo, L. S., Zbrun, M. V., Soto, L. P., Signorini, M. L. 2011. Effects of probiotics on growth performance in young calves: A meta-analysis of randomized controlled trials. Animal Feed Science and Technology. 169: 147-156.
3. Patel, S. Shukla, R., Goyal, A. 2015. Probiotics in valorization of innate immunity across various animal models. Journal of functional foods. 14: 549-561.
4. Lean, I. J., Golder, H. M., Hall, M. B. 2014. Feeding, evaluating, and controlling rumen function. Veterinary clinics of North America. Food Animal Practice. 30: 539-575.
5. Ospina, C. A. y F. Rodriguez. 2011. El ecosistema ruminal y los microorganismos con potencial probiótico. Pp. 41-59. En: Desarrollo de Probióticos para Ganaderias Productoras de Leche. F. Rodriguez y F. O. Carvajal. (Eds.). Bogota, Produmedios. 98 p.
6. Minuti, A., Ahmed, S., Trevisi, E., Piccioli-Cappelli, F., Bertoni, G., Jahan, N., Bani, P. 2014. Experimental acute rumen acidosis in sheep: Consequences on clinical, rumen, and gastrointestinal permeability conditions and blood chemistry. Journal of Animal Science. 92: 3966-3977.
7. Callaway, T., Carr, M. A., Edrington, T. S., Anderson, R. C., Nisbet, D. J. 2009. Diet, Escherichia coli 0157:H7, and cattle: A review after 10 years. Current issues in molecular biology. 11: 67-80.
8. Krehbiel, C. R., Rust, S. R., Zhang, G., Guilliland, S. E. 2003. Bacterial direct-fed microbials in ruminant diets: performance response and mode of action. Journal of Animal Science (E. Suppl. 2): E120-E132.
9. Bergey D. et al, Bergey's Manual of Determinative Bacteriology, novena edición, Baltimore: Williams & Wilkins, 1994.
10. Salarzar, R. 2003. Tecnologia Farmacéutica industrial. Tomo I y II. Fabricación industrial. Editorial Sintesis. Impreso en Espana. 1260 p.
11. REMINGTON, Joseph Price. Remington: The science and practice of pharmacy. 21th ed. Lippincott Williams & Wilkins. Philadelphia. USA. 2006
12. Rodriguez, F., Martin, E., Laverde, C., Mayorga, O. L., Carvajal, F., Rodriguez, T. A., Rodriguez, J. A. 2011. Manual de Laboratorio para el Estudio de Microorganismos Anaerobios Obligados. Produmedios. 36 p.

1) A microbial composition comprising, as an active ingredient, at least one probiotic microorganism selected among the group consisting of Fibrobacter succinogenes, Ruminococcus Flavefaciens, Streptococcus bovis and Butytrivibrio fibrisolvens, together with adjuvants and an acceptable carrier.

2) A microbial composition according to claim 1, wherein the concentration of the active ingredient in the composition ranges between 10.0% and 70.0% (w/w).

3) A microbial composition according to claim 1, wherein the concentration of each of the microorganisms of the active ingredient ranges between 1×10⁶ and 1×10¹⁰ CFU/mL.

4) A microbial composition according to claim 1, in the form of powder, soluble granulate, dispersible granulate, dispersible tablets, capsules, emulsion or suspension.

5) A microbial composition according to claim 1, in the form of a W/O emulsion comprising an aqueous phase, an oil phase, emulsifying agents, viscous agents and pH regulating agents.

6) A microbial composition according to claim 5, wherein the oil phase includes vegetable oils.

7) A microbial composition according to claim 5, wherein the vegetable oil is selected from the group consisting of sunflower oil, soybean oil, corn seed oil, canola oil, olive oil, coconut oil, wheat germ oil, and blends thereof.

8) A microbial composition according to claim 5, wherein the emulsifying agent is selected from the group consisting of lectin, polysorbates, sorbitan esters, noniphenol, sodium laurylsulfate, and blends thereof.

9) A microbial composition according to claim 5, wherein the pH regulating agent is selected from the group consisting of phosphates, citrates, borates and carbonates.

10) A microbial composition according to claim 5, wherein the viscosity agent is selected from the group consisting of polymers, gums, hydrocolloids, finely divided solids, waxes and blends thereof.

11) A microbial composition according to claim 5, having the following composition:

| COMPONENT | CONCENTRATION (%) |
|---|---|
| Adequate culture media | 40..00 |
| comprising probiotic | |
| microorganisms | |
| Sunflower oil | 49.96 |
| Polysorbate 20 | 1.84 |
| Liquid lectin | 5.95 |
| Hydrocolloid | 1.50 |
| Sodium bicarbonate | 0.75 |

12) A microbial composition according to claim 11, wherein the adequate culture media comprising probiotic microorganisms has the following composition:

| Component | Concentration (g/L) |
|---|---|
| Anaerobic Microorganisms | 1 × 10⁶-1 × 10¹⁰ CFU/mL |
| (Fibrobacter succinogenes, | |
| Ruminococcus Flavefaciens, | |
| Streptococcus bovis and | |
| Butytrivibrio fibrisolvens) | |
| Glucose | 2.0-40.0 |
| Yeast extract | 2.0-5.0 |
| Anaerobic indicator | 0.5-2.0 |
| Sodium bicarbonate | 3.0-10.0 |
| HCl-cysteine | 0.5-3.0 |
| Volatile fatty acids | 0.2-0.6 |
| KHPO₄ | 0.003-0.005 |
| KH₂PO₄ | 1.0-5.0 |
| Ammonium sulfate | 4.0-8.0 |
| NaCl | 4.0-6.0 |
| MgSO₄ | 3.50-5.00 |
| CaCl₂ | 0.5-1.0 |

13) A microbial composition according to claim 1, for the prevention of neonate diarrhea and increasing body weight in calves.

14) The use of a composition according to claim 1, for the prevention of neonate diarrhea and increasing body weight in calves.
